(19) United States
(12) Patent Application Publication
(10) Pub. No.: US 2015/0294415 A1
(43) Pub. Date: Oct. 15, 2015

(54) Multi-Scenario Trading Strategies

(71) Applicant: Trading Technologies International, Inc., Chicago, IL (US)

(72) Inventor: Scott F. Singer, Green Oaks, IL (US)

(73) Assignee: Trading Technologies International, Inc., Chicago, IL (US)

(21) Appl. No.: 14/253,191

(22) Filed: Apr. 15, 2014

(51) Int. Cl. G06Q 40/04

(52) U.S. Cl. CPC G06Q 40/04

(57) ABSTRACT

Multi-scenario trading strategies are disclosed. An example method includes storing a default configuration for a multi-scenario trading strategy; storing a first alternate configuration for the multi-scenario trading strategy, the default configuration being different than the first alternate configuration; presenting a switching option on an interface associated with the multi-scenario trading strategy; and in response to receiving a selection of the switching option while an instance of the multi-scenario trading strategy is operating according to the default configuration, causing the instance of the multi-scenario trading strategy to operate according to the first alternate configuration.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy which may be employed with certain disclosed embodiments.

FIG. 5 is a flowchart representative of example machine readable instructions that may be executed to implement disclosed embodiments.

FIG. 6 is a screenshot of an example interface which may be used to implement the disclosed embodiments.

FIG. 7 is a screenshot of an example interface which may be used to implement the disclosed embodiments.

FIG. 8 is a screenshot of an example presentation including information related to the multi-scenario trading strategy, which may be used to implement the disclosed embodiments.

FIG. 9 is a flowchart representative of example machine readable instructions that may be executed to implement disclosed embodiments.

FIG. 10 is a screenshot of an example interface which may be used to implement the disclosed embodiments.

FIG. 11 is a screenshot of an example multi-scenario trading strategies interface which may be used to implement the disclosed embodiments.

FIG. 12 is a flowchart representative of example machine readable instructions that may be executed to implement disclosed embodiments.

FIG. 13 is a block diagram representative of an example multi-scenario order management module that can implement the example machine readable instructions of FIGS. 5, 9 and/or 12.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The disclosed embodiments relate to trading systems and methods. More specifically, the disclosed embodiments relate to systems and methods to provide trading strategies having multiple scenarios (also referred to as “stages” or “configurations”, for example) between which a user (which may be a person and/or a trading device acting on behalf of the person) can rapidly switch while the trading strategies are working A working trading strategy is one having an active instance that is currently monitoring market data and/or placing trade order(s), for example.

The disclosed embodiments recognize that when a change is desired for an instance of a trading strategy, the time it takes the user to navigate through the reconfiguration interface of known systems may be detrimental. For example, the market condition on which the desired change was based may no longer exist by the time the user is able to reconfigure the parameters of the instance of the trading strategy (for example, via the reconfiguration interface).

To reduce the amount of time needed to reconfigure an instance of a working trading strategy that manages one or more trade orders, the disclosed embodiments include multi-scenario trading strategies that enable the user to change an active trading strategy instance(s) from operating according to one set of parameters to operating according to another, different set of parameters without having to open and navigate through a reconfiguration interface (for example, a reconfiguration dialogue or window) when a change is desired. Put another way, the disclosed embodiments enable the user to change an active trading strategy from operating according to a first scenario configured with first parameter(s) to operating according to a second scenario configured with second parameter(s) different from the first scenario without having to take the time necessary to configure the second scenario while the corresponding trading strategy instance(s) is active. For example, when the first and second scenarios of a trading strategy disclosed herein are spreads, the first scenario includes a first number of active legs and the second scenario includes a second, different number of active legs and/or different legs altogether. Using the multi-scenario trading strategies disclosed herein, the trading strategy can be switched, via a selection of the second scenario from an interface, from working the first number of legs to working the second number of legs without requiring the configuration of the second number of legs while the corresponding instance of the trading strategy is active.

The embodiments disclosed herein provide an ability to switch between predefined parameters or strategies via, for example, a single click of an interface button on an order book and/or an automated script associated with a trading strategy. That is, instead of having to reconfigure an active trading strategy instance on the fly, the disclosed embodiments provide a user interface element (for example, a button) that implements different trading parameters desired for the trading strategy. In particular, the embodiments disclosed herein enable generation of trading strategies having multiple scenarios between which the user can switch. Each scenario of the multi-scenario trading strategies provided by the disclosed embodiments is configured differently. In some examples provided by the disclosed embodiments, the scenarios differ in one or more configuration parameters that define a current configuration for the trading strategy. In some examples provided by the disclosed embodiments, an option to create the predefined scenarios is presented to the user in connection with creation (for example, an initial configuration process) of the trading strategy. In some embodiments disclosed herein, one of the scenarios of a multi-scenario trading strategy is designated as a default scenario and the other scenarios are designated as alternate scenarios (for example, alternate configurations or trade stages). The disclosed embodiments enable rapid switching between the default scenario and one of the alternate scenarios and/or between different ones of the alternate scenarios all without requiring the user to navigate a reconfiguration interface (after the initial configuration of the predefined scenarios). Thus, the disclosed embodiments enable rapid, switching between order configurations on the fly. In some embodiments, when data corresponding to the different scenarios or configurations is stored at a server or other central computing device, instructions to switch between scenarios (for example, by sending an index or identifier of the desired scenario) are sent between a trading device (for example, a client device) and the server rather than the entire set of configuration information including operating parameters such as, for example, working leg(s), identification information and tags, parameter values, start time, duration, and other necessary information for operation of the scenario. In some embodiments, switching between scenarios is automatically accomplished upon detection of a market condition or event such as a price threshold, a volume trigger or other market driven That is, the disclosed embodiments provide reductions in network communications and latency associated with switching between different scenarios of trading strategies.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide an example method including receiving, by a trading device, a definition for a multi-scenario trading strategy describing trade orders to be placed in at least one market, wherein receiving the definition includes: storing a default configuration for the multi-scenario trading strategy having a first leg and a second leg, and storing an alternate configuration for the multi-scenario trading strategy having the first leg and at least a third leg and wherein the second and the third legs are different. The method further comprises implementing an instance of the multi-scenario trading strategy, wherein the current instances operates according to the default configuration, placing a trade order in the at least one market such that the trade order works in the market according to the default configuration, detecting, at the trading device, a market event related to the trade order implemented in accordance with the current instance of the multi-scenario trading strategy, and switching the operation of the current instance, in response to the detected market event, between the default configuration to the alternate configuration such that the current instance operates according to the alternate configuration while maintaining the operation of the instance.

Certain embodiments provide a tangible computer readable storage medium comprising instructions that, when executed, cause a machine to at least receive a definition for a multi-scenario trading strategy describing trade orders to be placed in at least one market, wherein the received the definition includes a default configuration for the multi-scenario trading strategy having a first leg and a second leg, and an alternate configuration for the multi-scenario trading strategy having the first leg and at least a third leg and wherein the second and the third legs are different, implement an instance of the multi-scenario trading strategy, wherein the current instances operates according to the default configuration, place a trade order in the at least one market such that the trade order works in the market according to the default configuration, detect, at the trading device, a market event related to the trade order implemented in accordance with the current instance of the multi-scenario trading strategy, and switch the operation of the current instance, in response to the detected market event, between the default configuration to the alternate configuration such that the current instance operates according to the alternate configuration while maintaining the operation of the instance.

Certain embodiments provide an example apparatus including a computing device to enable a user to define a plurality of configurations for a multi-scenario trading strategy, the computing device responsive to a market event while an instance of the multi-scenario trading strategy is active and operating in accordance with one of the plurality of configurations of the multi-scenario trading strategy, wherein the computing device responds to receipt of the market event while the instance is active by switching the instance from operating in accordance with the current configuration to operating in accordance with a second configuration of the multi-scenario trading strategy without requiring the user to navigate a reconfiguration interface.

### II. Example Electronic Trading System

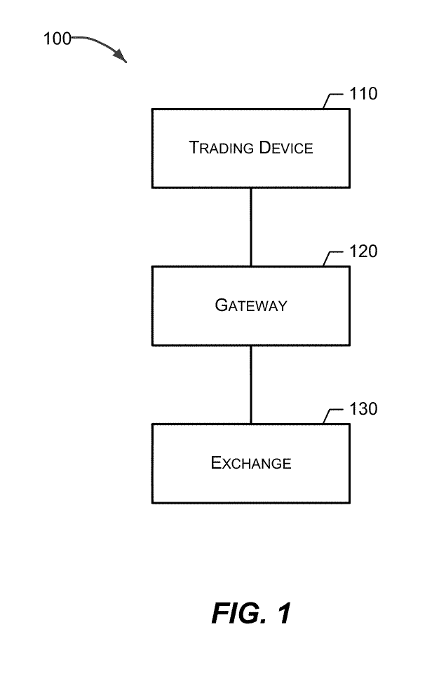

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

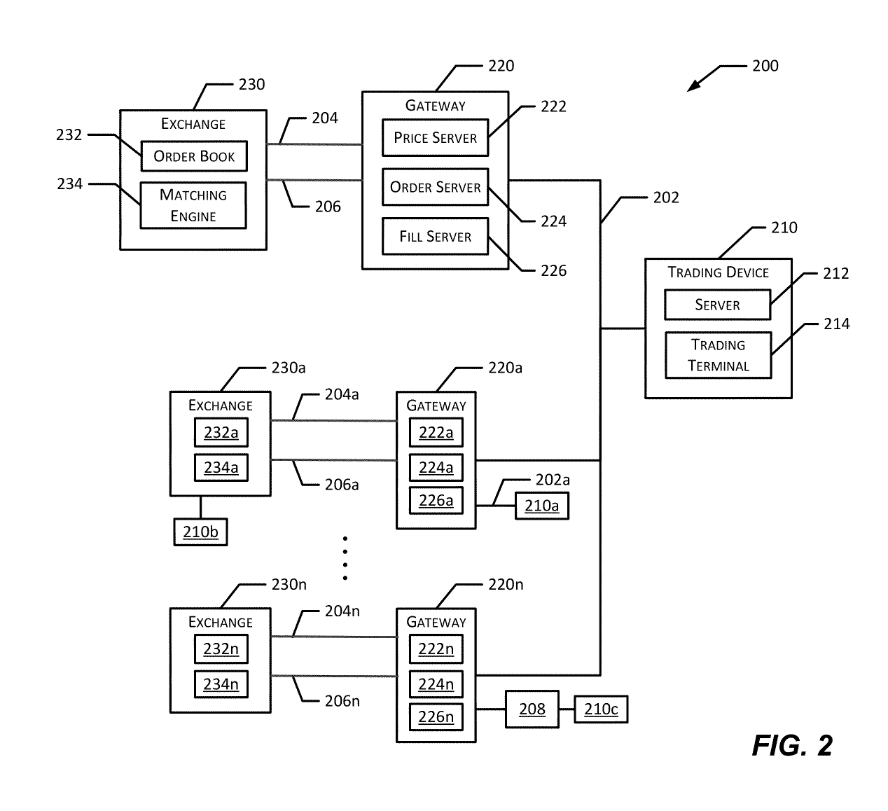

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

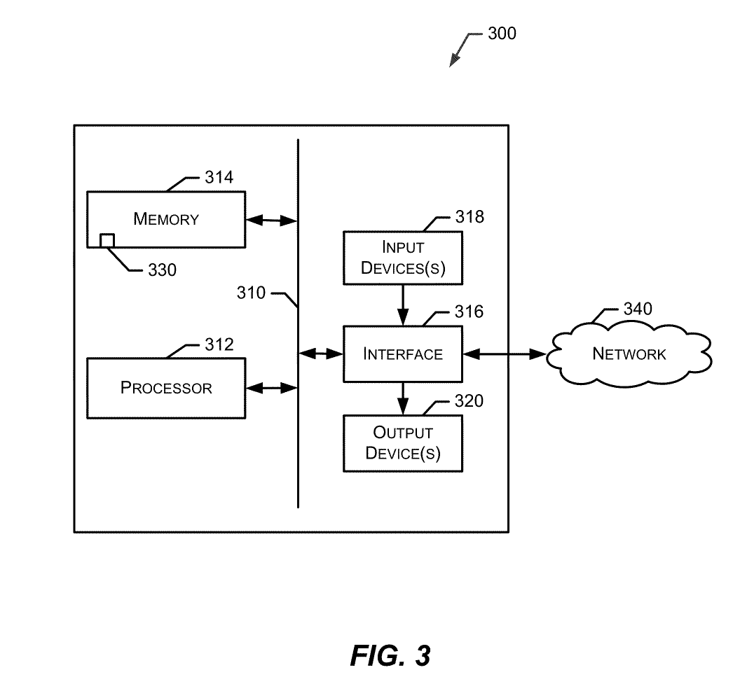

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable objects in the trading strategy, for example.

An automated trading tool may be utilized to trade according to a trading strategy, for example. For example, the automated trading tool may AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

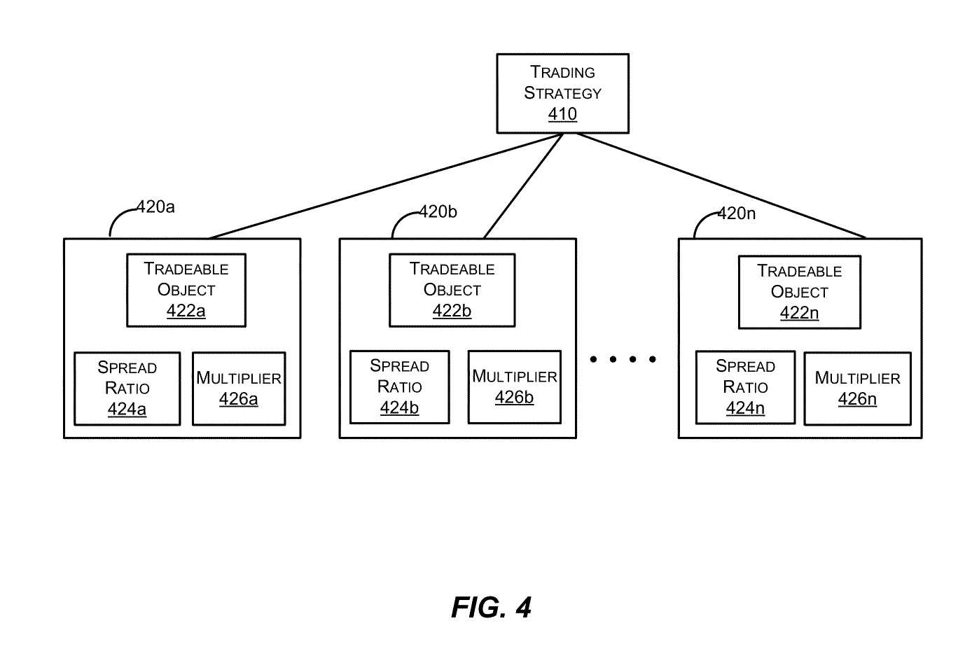

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420 comprising the tradeable objects 422 multiplied by corresponding multipliers 426. The price for a trading strategy may be affected by price tick rounding and/or pay-up ticks. However, both of these implementation details are beyond the scope of this discussion and are well-known in the art.

As discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned-on price, lean price, or lean level. Typically, if there is sufficient quantity available, the target price may be the best bid price when selling and the best ask price when buying. The target price may be different than the best price available if there is not enough quantity available at that price or because it is an implied price, for example. As the leaned-on price changes, the price for the order in the quoting leg may also change to maintain the desired strategy price.

The leaned-on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned-on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Multi-Stage Trading Strategies

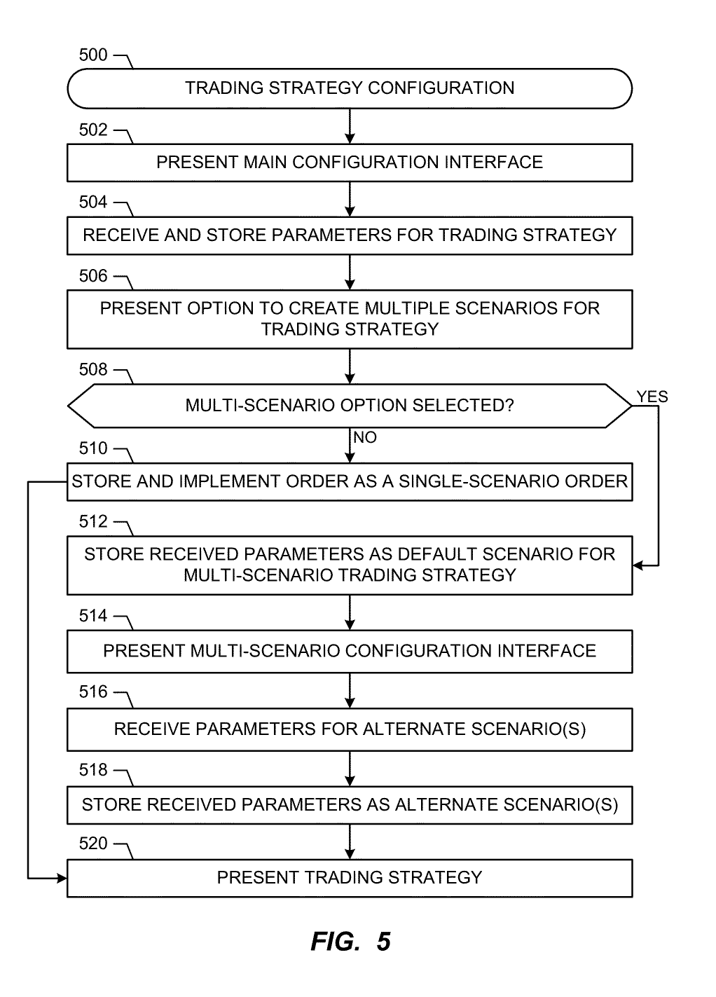

FIGS. 5, 8 and 10 are flowcharts representative of example operations that can be executed to implement teachings of this disclosure. At least some of the example operations of FIGS. 5, 8 and 10 can be implemented by, for example, the trading application 330 stored on and executed by the example trading device 110 of FIG. 1 and/or the example trading device 210 of FIG. 2. Additionally or alternatively, at least some of the example operations of FIGS. 5, 8 and 10 can be implemented by, for example, one or more applications stored on and executed by the example exchanges 230a-230n of FIG. 2 and/or the example gateways 220a-220n of FIG. 2. While the example trading device 110 of FIG. 1 is described as implementing the example operations of FIGS. 5, 8 and 10 below, any suitable device can implement the example operations of FIGS. 5, 8 and 10.

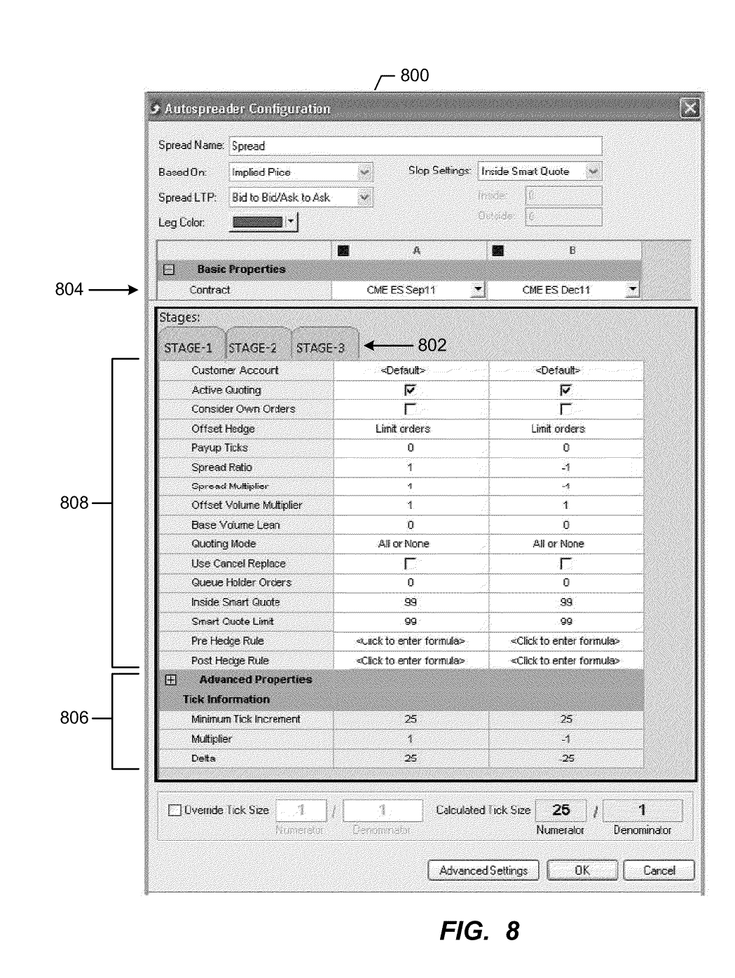

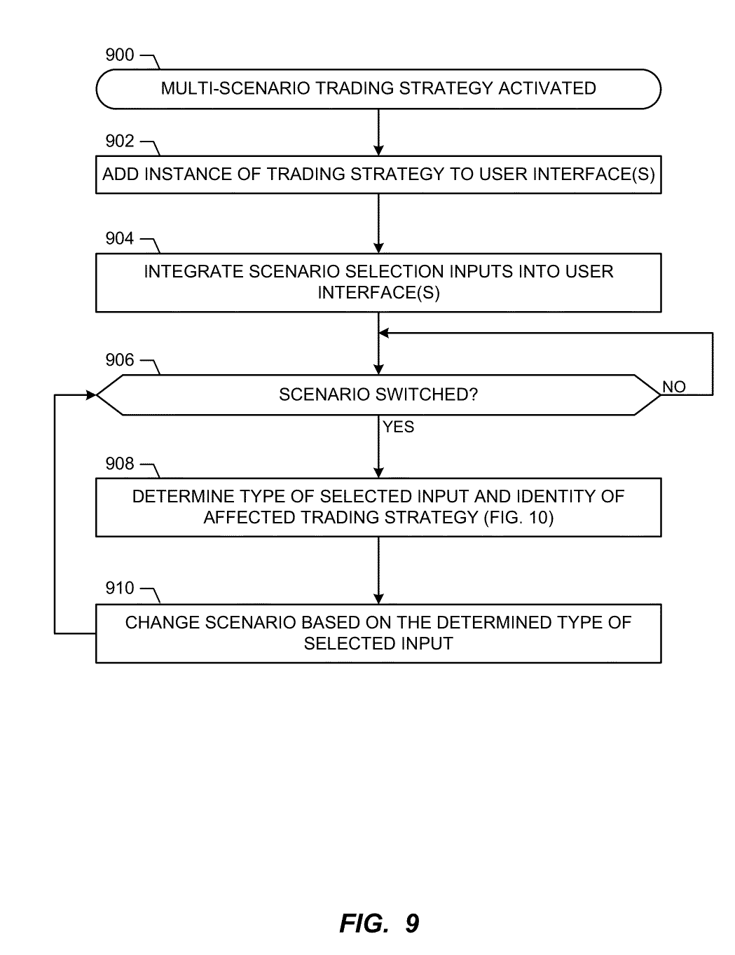

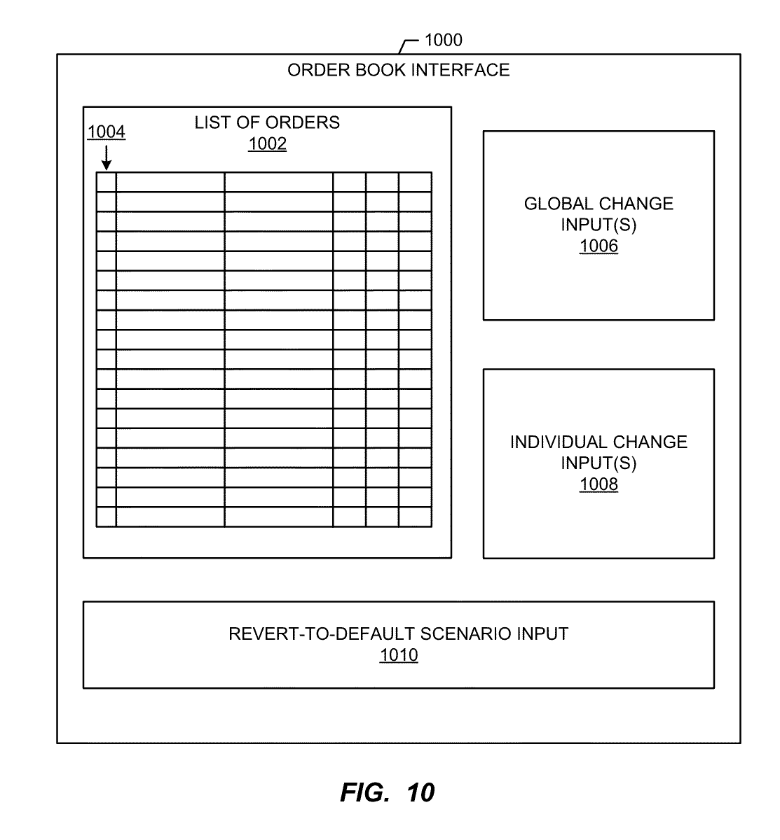

The example operations of FIGS. 5, 8 and 10 enable a multi-scenario trading strategy capable of operating according to one of a plurality of selectable predefined scenarios at any given time. Each of the scenarios represents a particular configuration for the trading strategy defined by one or more parameters and/or settings. As described below in connection with FIGS. 5-7, definitions for the individual scenarios are established via, for example, a multi-scenario configuration interface presented to a user in connection with an order configuration interface. Scenario definitions may include parameters defining the trading strategy to be executed, market events associated with one or more scenario, user-defined trigger or switching conditions, interface and/or notification setting and other configuration parameters. Scenario definitions may further include the entire set of configuration information including operating parameters and other necessary data and information for operation of the scenario. Market events may include one or more change in price or quantity, a time or date parameter, a news event, an economic indicator and other quantifiable circumstances or information. As described below in connection with FIGS. 8 and 9, any of the predefined scenarios can be selected while instance(s) of the multi-scenario trading strategy are working to change the parameters by which the instance(s) are operating. Notably, as the scenarios have already been defined in connection with the creation of the trading strategy, changes to current configuration can be executed without having to enter reconfiguration data for the currently active instances of the one or more trading strategies. For example, the system automatically switches the trade order(s) of one or more active instances of the trading strategy from operating according to a first configuration (a set of parameters and settings, for example) to operating according to a second configuration (a set of parameters and settings, for example). In operation, the automatic switching between configurations is triggered upon detection or determination of a market event without requiring the user to navigate through a reconfiguration interface, or delete and submit replacement orders. Thus, the change in configurations is accomplished while the overall multi-scenario trading strategy is in continuous operation. As described below in connection with FIG. 10, different types of selections can be made in connection with the multi-scenario trading strategy that have different effect(s).

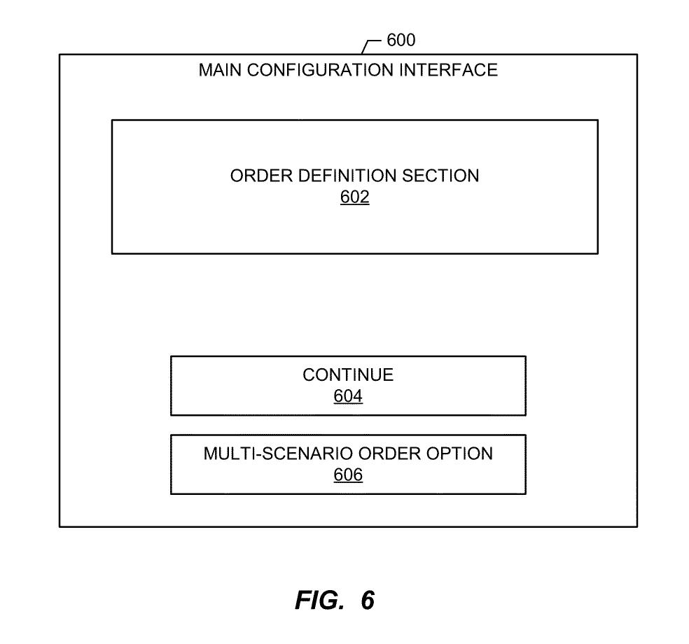

The example of FIG. 5 begins with an indication that a trading strategy is being created via the example trading device 110 of FIG. 1 (block 500). In the illustrated example, the trading strategy being created involves a spread being configured via, for example, an instance of AUTOSPREADER® running on the example trading device 110 of FIG. 1. However, any suitable type of trading strategy being created via any suitable program and/or interface is possible. To enable creation of the spread, a main configuration interface is presented via, for example, a display associated with the example trading device 110 of FIG. 1 (block 502). An example main configuration interface 600 is shown in FIG. 6. In the illustrated example of FIG. 6, the main configuration interface 600 includes an order definition section 602 to receive input regarding setting(s), parameter(s), value(s), etc. to define one or more aspects the trading strategy. For example, the order definition section 602 receives input related to desired quoting leg(s) and hedge leg(s) of a spread. Example information to be entered via the order definition section 602 includes tradeable object identifier(s), price(s), one or more quantities, date(s), tick(s), ratio(s), market identifier(s), time(s), etc. With reference to FIG. 4, the order definition section 602 of FIG. 6 receives data identifying the tradeable objects 422, the spread ratios 424, the multipliers 426, and/or any additional or alternative aspect(s) of the spread 410.

In the example of FIG. 5, parameters received via the order definition section 602 are stored in connection with identifying information assigned to the trading strategy being created (block 504). When the necessary information has been received for at least one configuration or scenario for the trading strategy being created, an option to designate the trading strategy as a single scenario trading strategy is presented. The example main configuration interface 600 of FIG. 6 includes a continue button 604 that is engaged when a single-scenario trading strategy is desired. Additionally, an option to designate the trading strategy as a multi-scenario trading strategy is presented in the example of FIG. 5 (block 506). That is, the multi-scenario option is presented to enable more than one configuration and/or set of parameters to be defined for the trading strategy. The example main configuration interface 600 of FIG. 6 includes a multi-scenario order option button 606 that is engaged when a multi-scenario trading strategy is desired.

If the continue button 604 is engaged, the trading strategy is stored and implemented as a conventional, single-scenario trading strategy (block 510). Control then proceeds to block 520 and the trading strategy is presented. In the example of FIG. 5, if the multi-scenario order option button 606 is engaged (block 508), the parameters already entered in the order definition section 602 are stored as a default scenario configuration for the trading strategy (block 512). In the illustrated example, the default scenario configuration corresponds to the initial settings and/or strategy of the trading strategy to be executed when the multi-scenario trading strategy is activated. As described below in connection with FIG. 8, the trading strategy operates according to the default scenario unless or until a different scenario is selected (for example, by a user) or otherwise activated (for example, by an automated script). The different scenarios defined for the trading strategy in addition to the default scenario are referred to as alternate scenarios.

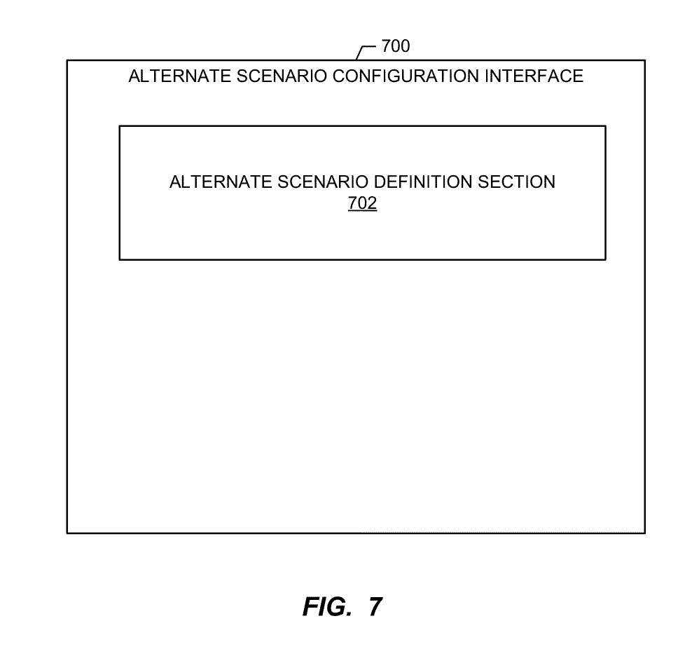

For example, an alternate scenario configuration interface is presented in response to an indication that a multi-scenario trading strategy is desired (for example, via a selection of the multi-scenario option button 606) (block 514). An example alternate scenario configuration interface 700 having an alternate scenario definition section 702 is shown in FIG. 7. The example alternate scenario definition section 702 of FIG. 7 receives data similar to the data received by the example order definition section 602 of FIG. 6 (block 516). In some examples, the alternate scenario definition section 702 of FIG. 7 is automatically populated with the data of the default scenario as a starting set of parameters for the alternate scenario, one of which is to be changed to define the alternate scenario. For example, if the default scenario is configured to have three quoting legs active in a particular market, the alternate scenario may be configured to have only one of the quoting legs active in the particular market. Additionally or alternatively, the alternate scenario may be configured to have the three quoting legs active in a different market than the default scenario. Additionally or alternatively, the alternate scenario may be configured to have one or more differences in quantity for one or more of the three quoting legs. Additionally or alternatively, the alternate scenario may be configured to have completely different quoting leg(s) active.

Thus, the alternate scenario can differ from the default scenario in any suitable fashion and/or any suitable aspect(s). Moreover, multiple alternate scenarios can be defined for the trading strategy via, for example, one or more additional entries in the alternate scenario definition sections 702. That is, any number of alternate scenarios that differ in any suitable fashion and/or aspect(s) from each other and/or the default scenario is possible. While the illustrated examples include the main configuration interface 600 of FIG. 6 and the alternate scenario definition section 702 of FIG. 7, the default scenario and the alternate scenario(s) may be configured on the same interface.

In the example of FIG. 5, the alternate scenario(s) and the settings thereof are stored in connection with identifying information of the trading strategy (block 518). For example, the trading device 110 of FIG. 1 implementing the example operations of FIG. 5 stores (for example, locally and/or remotely) data indicative of the predefined scenarios for the trading strategy such that the trading device 110 has access to the configurations of the scenarios. Further, information related to the multi-scenario trading strategy is presented via, for example, the trading device 110 (block 520).

FIG. 8 is a screenshot of an example presentation including information related to the multi-scenario trading strategy. In particular, the example of FIG. 8 is a screenshot of an interface 800 associated with AUTOSPREADER® and associated with the multi-scenario trading strategies disclosed herein. The example interface 800 of FIG. 8 includes a plurality of tabs 802 that enable switching between different ones of the multiple scenarios defined for the trading strategy. In the example of FIG. 8, the scenarios are referred to as stages, which is interchangeable with the term scenario as used herein. The example interface 800 of FIG. 8 presents the information and enables reconfiguration of one or more aspects of the trading strategy. In the example of FIG. 8, a contract parameter 804 is reconfigurable for a selected one of the scenarios. In the example of FIG. 8, tick parameters 806 are reconfigurable for the selected one of the scenarios. The example of FIG. 8 includes a list 808 of other parameters associated with the trading strategy. While certain ones of the parameters presented in FIG. 8 are reconfigurable for the different scenarios in the example of FIG. 8, additional or alternative parameters may be reconfigurable, locked, etc. That is, any desired combination of making certain parameters locked and certain parameters reconfigurable is possible.

FIG. 9 begins with an indication that a multi-scenario trading strategy has been activated (block 900). That is, one or more instances of the multi-scenario trading strategy is monitoring one or more markets and, if appropriate, sending one or more order messages to one or more exchanges based on the definition of the corresponding trade order(s) and the market conditions. In the example of FIG. 9, one or more inputs corresponding to an instance of the multi-scenario trading strategy are added to one or more user interfaces (block 902). In some examples, the active instance(s) of the multi-scenario trading strategy are added to a general order monitoring user interface that includes entries for different types of trading strategies, such as single-scenario trading strategies and multi-scenario trading strategies. In some examples, the instance(s) of the multi-scenario trading strategy are added to a user interface dedicated to multi-scenario trading strategy. FIG. 10 is a screenshot of an example order book interface 1000 onto which the multi-scenario trading strategy is added. The example order book interface 1000 of FIG. 10 includes a list of orders 1002 that represents working trade orders associated with a corresponding user. The example order book interface 1000 of FIG. 10 is utilized to, for example, monitor the orders of the list 1002 and/or make changes to one or more of the orders of the list 1002. In the illustrated example of FIG. 10, the list 1002 includes trade orders associated with single-scenario trading strategies and trade orders associated with instances of multi-scenario trading strategies. Thus, the example list 1002 may include one or more reference indicators 1004 corresponding to the active and/or available instances of multi-scenario trading strategies and single-scenario trading strategies.

In the example of FIG. 9, input(s) associated with multi-scenario trading strategies are integrated into one or more user interface elements, such as an order book interface (block 904). In the illustrated example, integration of the multi-scenario trading strategy input(s) involves displaying the input(s) in response to a multi-scenario trading strategy being selected (for example, highlighted) in the list of orders 1002 of FIG. 10. Additionally or alternatively, one or more multi-scenario trading strategy inputs may be permanently displayed on certain user interface element(s). In some examples, different types of multi-scenario inputs are integrated into the user interface element(s). For example, some trading strategies have a plurality of instances working at the same time. In such instances, the example of FIG. 9 integrates one or more global change inputs that cause each instance of a selected multi-scenario trading strategy to switch scenarios. An example global change input section 1006 is shown in the example of FIG. 10 in response to, for example, a multi-scenario trading strategy being selected from the list 1002. In the illustrated example, the global change input section 1006 includes an entry for each predefined alternate scenario stored for the selected multi-scenario trading strategy. For example, an identifier associated with each alternate scenario predefined for the selected multi-scenario trading strategy is displayed in the global change input section 1006. The entries in the example global input section 1006 are selectable via, for example, a cursor and/or keyboard being operated by a user. However, selection of the alternate scenario(s) may also be implemented by a trading device (for example, by the trade device 110 according to an automated script and/or in response to the detection of a market event). When more than one instance of the selected multi-scenario trading strategy is currently active, selection of one of the input(s) of the example global change section 1006 causes each instances of the trading strategy to switch to the selected predefined alternate scenario.

As an illustrative example, an alternate scenario of a trading strategy may involve a trade order that includes a currency conversion. The alternative scenario of the trading strategy was defined such that a multiplier of one of the legs has a constant value to statically account for the currency conversion. Additionally, a default scenario of the trading strategy uses an additional spread leg that is itself a currency market. The example multi-scenario trading strategy enables the user to switch scenarios to the alternate scenario when, for example, a lack of liquidity in the currency market is detected, and/or when that market is about to end its trading session.

In the example of FIG. 9, individual change input(s) are also integrated into the user interface (block 904). An example individual change input section 1008 is displayed in the example order book interface 1000 of FIG. 10 in response to, for example, a multi-scenario trading strategy being selected from the list 1002. In the illustrated example, the individual change input section 1008 includes an entry for each predefined alternate scenario stored for the selected multi-scenario trading strategy. For example, an identifier associated with each alternate scenario predefined for the selected multi-scenario trading strategy is displayed in the individual change input section 1008. The entries in the example individual input section 1008 are selectable via, for example, a cursor and/or keyboard being operated by a user. However, selection of the alternate scenario(s) may also be implemented by a trading device (for example, by the trading device 110 according to an automated script). When more than one instance of the selected multi-scenario trading strategy is currently active, selection of one of the input(s) of the example individual change input section 1008 causes the selected instances of the trading strategy to switch to the selected predefined alternate scenario. For example, unselected instance(s) of the multi-scenario trading strategy continue operating according to a current scenario (for example, the default scenario) without changing in accordance with the selection from the individual change input section 1008. In some examples, a subset of the active instances of a trading strategy can be simultaneously selected (for example, by clicking on the individual instances while holding down a CONTROL key on a keyboard) and one of the input(s) of the individual change input section 1008 can be selected. Accordingly, the selected change in scenario applies to the subset of the instances of the multi-scenario trading strategy.

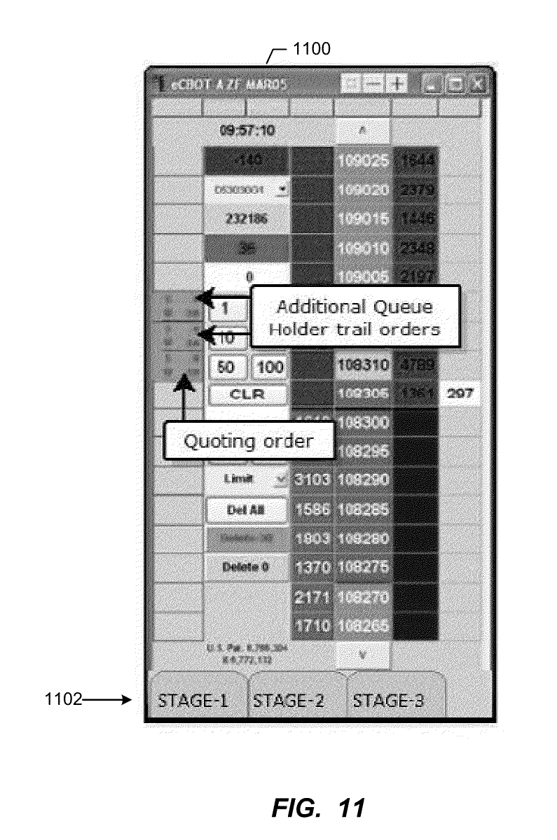

While the example of FIG. 10 includes an order book interface 1000 into which the multi-scenario input(s) are integrated, additional or alternative input(s) may be integrated into additional or alternative user interface(s) and/or user interface element(s). For example, an MDTrader® window 1100 having inputs 1102 dedicated to multi-scenario trading strategies is shown in FIG. 11. In the example of FIG. 11, the inputs 1102 can be selected to change between different ones of the scenarios of the multi-scenario trading strategy. Inputs related to multi-scenario trading strategies may be integrated and grouped together for purposes of switching between the scenarios in any other suitable window.

In the example of FIG. 9, a revert-to-default input is also integrated into the user interface (block 904). An example revert-to-default input 1010 is shown in the example of FIG. 10 when, for example, a multi-scenario trading strategy (for example, a currently highlighted entry in the list 1002) is operating according to an alternate scenario. The example revert-to-default input 1010 of FIG. 10 enables the user to return to the initial configuration of the corresponding trading strategy.

Any of the inputs related to the multi-scenario trading strategies may be selected for any desirable purposes or in response to any desirable event. As an illustrative example, a trading strategy may involve a trade order that includes a currency conversion. The example trading strategy was defined such that a multiplier of one of the legs has a constant value to statically account for the currency conversion. Alternatively, the trading strategy may use an additional spread leg that is itself a currency market. In some examples, the default scenario includes the additional spread leg being active and the alternate scenario includes the constant value for the multiplier. The example multi-scenario trading strategy enables the user to switch the current scenario to the alternate scenario when a lack of liquidity in the currency market is detected, as well as when that market is about to end its trading session.

Another illustrative example involves a yield curve trader that wants to hedge in different contracts depending on market conditions. Suppose that a trading strategy that starts with a position in a 2-year treasury contract in which the user would accept hedging in either a 5-year or a 10-year contract. In such examples, a default scenario for a multi-scenario trading strategy may include one leg as the 5-year treasury contract, while an alternate scenario may include a different leg involving the 10-year contract. Additionally or alternatively, one or more parameters of the alternate leg may be different.

Another illustrative example involves one or more alternate scenarios that vary a tick size of the trading strategy. This would be useful when monitoring a market (larger tick size) versus trying to accurately enter trade orders (smaller tick size).

Another illustrative example involves ratio quantity variations between scenarios. Some spreads have an “ideal” ratio that cannot be achieved due to trade sizes being used. For example, a spread that is ideally a 100:66 ratio can only be configured as 10:6 or 10:7. Such spreads may form the different scenarios of a multi-scenario trading strategy. For example, 10:6 may be the default scenario and the user may switch to an alternative scenario in an attempt to try to get a different leg quantity closer to the ideal ratio.

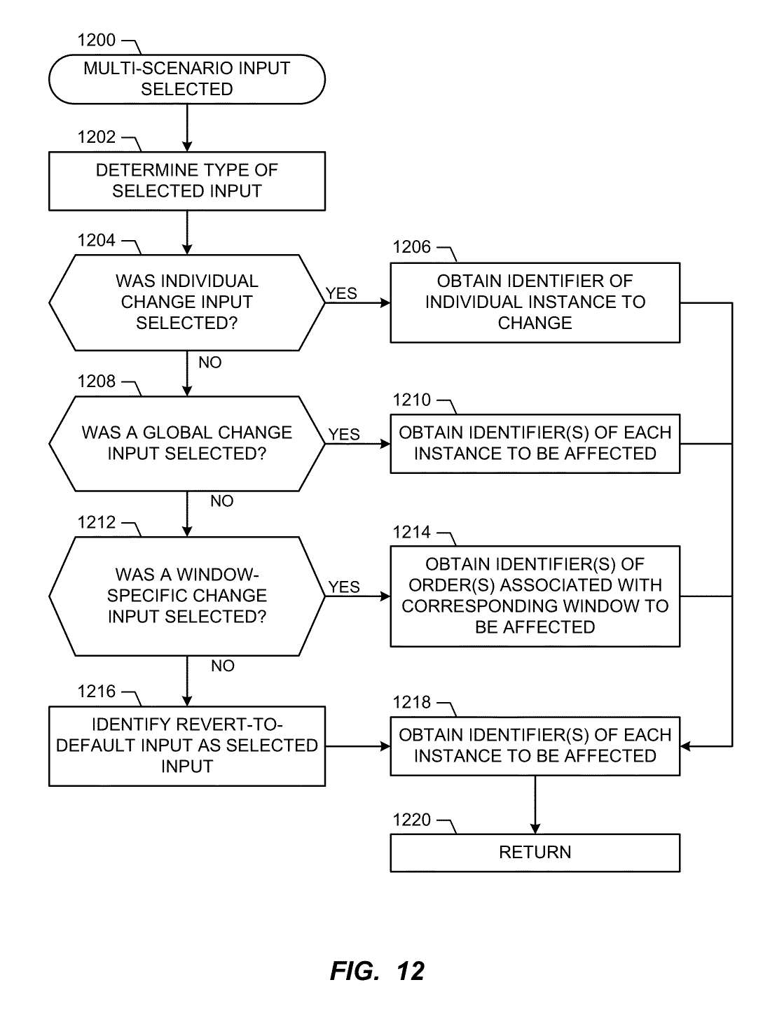

When one of the multi-scenario inputs (for example, one of the inputs 1006-1008 of FIG. 10) is selected in the example of FIG. 9 (block 906), the type of the selected input and the identity of the affected one or more trading strategies and/or instance(s) of the trading strategies is determined (block 908). An example of such determinations is shown in FIG. 12 and is described in detail below. Based on the indication of which type of input was selected and the identity of the affected trading strategies, the example of FIG. 9 changes to the selected scenario (block 910). For example, if the selected input was from the global change input section 1006 of FIG. 10, each instance of the corresponding trading strategy is changed to the selected scenario. Alternatively, if the selected input was from the individual change input section 1008 of FIG. 10, the corresponding trading strategy is changed to the selected scenario. Alternatively, if the selected input corresponds to the revert-to-default input 1010 of FIG. 10, the trading strategy begins operating according to the initial or default scenario. In the illustrated example, changing the scenario of the trading strategy includes referencing the corresponding previously established definition for the selected scenario and changing one or more parameters, settings, values, etc. of the trading strategy such that the trade order(s) thereof operates according to the predefined configuration. Control then returns to block 906.

FIG. 12 begins with an indication that a multi-scenario input has been selected from, for example, the order book interface 1000 of FIG. 10 (block 1200). In the example of FIG. 12, a type of the selected input is determined by, for example, analyzing input provided via the user interface and/or by an automated tool (for example, a script implemented by the example trading device 110 of FIG. 1) (block 1202). If the selected input is an individual change input (block 1204), an identifier of the corresponding instance of the trading strategy is obtained (block 1206). If the selected input is a global change input (block 1208), identifier(s) of each instance of the trading strategy are obtained (block 1210). If the selected input is a window-specific change input (block 1212), identifier(s) of the applicable instance(s) of the trading strategies are obtained (block 1214). In the illustrated example of FIG. 12, the selected input is assumed to be the revert-to-default input if no other type is determined (block 1216). If so, the identifier(s) of each instance of the trading strategy are obtained (block 1218). As described above, the obtained identifier(s) and the determined type of the selected input is used to change the scenario of the corresponding trading strategy.

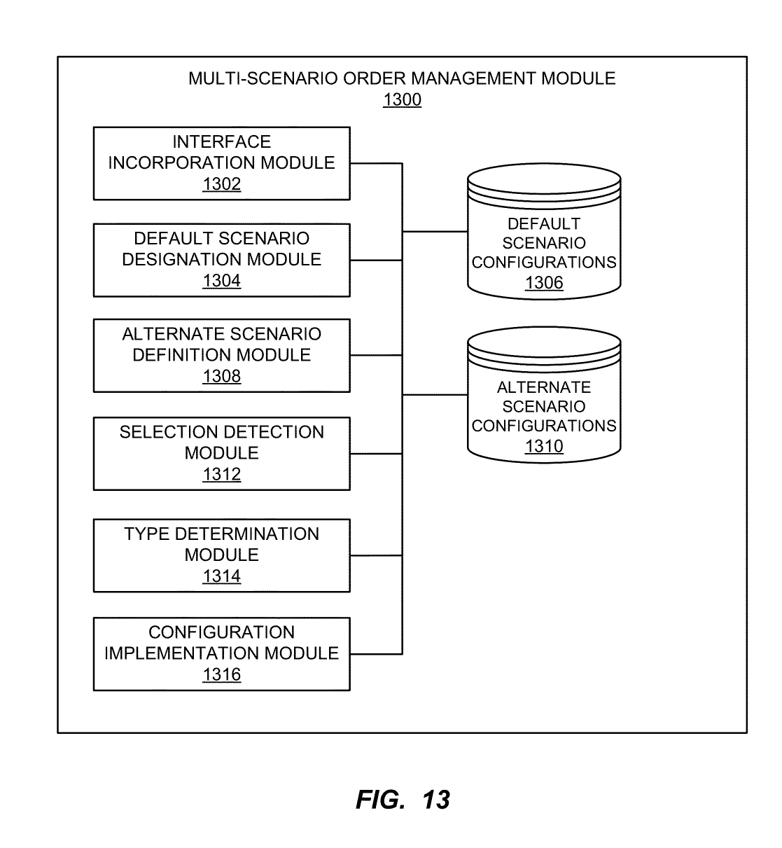

FIG. 13 is a block diagram of an example multi-stage order management module 1100 that may implement and/or execute the example operations of FIGS. 5, 8 and/or 10. In some examples, the multi-stage order management module 1300 of FIG. 13 may be implemented as a part of the trading application 330 associated with the trading device 110 of FIG. 1, the trading device 210 of FIG. 2, and/or the gateway(s) 220a-n of FIG. 2. In some examples, the multi-stage order management module 1300 of FIG. 13 may be implemented as computer implemented code or instructions operable independent of a trading application. In some examples, the features and functionality of the multi-stage order management module 1300 of FIG. 13 may be implemented in hardware operable in connection with the trading device 110 of FIG. 1, the trading device 210 of FIG. 2, and/or the gateway(s) 220a-n of FIG. 2.

The example multi-stage order management module 1300 of FIG. 13 includes an interface incorporation module 1302 to incorporate user interface elements associated with the example multi-scenario trading strategies disclosed herein into one or more interfaces. In the illustrated example of FIG. 13, the interface incorporation module 1302 adds the example multi-scenario order option 606 to the example main configuration interface 600 of FIG. 6, implements the example alternate scenario configuration interface 700 of FIG. 7, adds the example indicators 904 to the list 902 of FIG. 9, and integrates the multi-scenario inputs 906-910 of FIG. 9 into the order book interface 900.

The example multi-stage order management module 1300 of FIG. 13 includes a default scenario designation module 1304 to differentiate the default scenario of a multi-scenario trading strategy from the alternate scenario(s) of the multi-scenario trading strategy. In the illustrated example, if the multi-scenario button 606 of FIG. 6 is selected to indicate a desire to create a multi-scenario trading strategy, the default scenario designation module 1304 designates information entered into the example order definition section 602 as the default scenario or configuration for the trading strategy being created. In some examples, the default scenario designation module 1304 also handles the designation of the trading strategy as a single-scenario trading strategy when, for example, the continue button 604 of FIG. 6 is selected without the multi-scenario order option 604 being selected. To designate the received information as the default scenario for the multi-scenario trading strategy, the example default scenario designation module 1304 of FIG. 13 sends the corresponding data to a default scenario configuration database 1306, which stores the data in an accessible manner (for example, by assigning identification information, storing the data accordingly, and making the identification information available to users and/or applications with authorization to such information).

The example multi-stage order management module 1300 of FIG. 13 includes an alternate scenario designation module 1308 to manage the alternate scenario(s) of a multi-scenario trading strategy. In the illustrated example, if data is entered into the alternate scenario configuration interface 700 of FIG. 7, the alternate scenario designation module 1308 designates the entered data as the alternate scenario(s) or configuration(s) for the trading strategy being created. The example alternate scenario designation module 1308 of FIG. 13 sends the corresponding data to a alternate scenario configuration database 1310, which stores the data in an accessible manner (for example, by assigning identification information, storing the data accordingly, and making the identification information available to users and/or applications with authorization to such information).

The example multi-stage management module 1300 of FIG. 13 includes a selection detection module 1312 to determine whether a multi-scenario input has been selected on any suitable user interface. For example, the selection detection module 1312 determines whether any of the inputs 906-910 of FIG. 9 has been selected. Additionally or alternatively, the example selection detection module 1312 of FIG. 13 determines whether a device has selected a multi-scenario option (for example, an automated script implemented via the trading device 110 of FIG. 1). For example, the selection detection module 1312 of FIG. 13 is configured to receive data from such a device when a desired change in scenario is selected. In the illustrated example, the selection detection module 1312 responds to a selection by engaging a type determination module 1314 to determine a type of the selection. As described above, different types of multi-scenario inputs are provided and may be selected in connection with one or more trading strategies and/or one or more instances of trading strategies. The example type determination module 1314 of FIG. 11 identifies the type of the selection by, for example, analyzing data associated with the selection, such as metadata and/or user interface coordinate information.

The example multi-stage management module 1300 of FIG. 13 includes a configuration implementation module 1316 to facilitate the change(s) associated with a selection of a multi-scenario input, as detected by the selection detection module 1312 and identified by the type determination module 1314. The example configuration implementation module 1316 of FIG. 13 retrieves the applicable scenario data from the default scenario configuration database 1306 (for example, when the detected selection corresponds to the revert-to-default input 910 of FIG. 9) or the alternate scenario database 1310 (for example, when the detected selection corresponds to one of the inputs of the global change section 906 or the individual change section 908). The example configuration implementation module 1316 uses the obtained data to alter parameter(s), value(s), setting(s), etc. of the applicable trading strategies and/or instances of the trading strategies to implement the selected scenario.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method, comprising:
receiving, by a trading device, a definition for a multi-scenario trading strategy describing trade orders to be placed in at least one market, wherein receiving the definition includes:
storing a default configuration for the multi-scenario trading strategy having a first leg and a second leg;
storing an alternate configuration for the multi-scenario trading strategy having the first leg and at least a third leg and wherein the second and the third legs are different;
implementing an instance of the multi-scenario trading strategy, wherein the current instances operates according to the default configuration;
placing a trade order in the at least one market such that the trade order works in the market according to the default configuration;
detecting, at the trading device, a market event related to the trade order implemented in accordance with the current instance of the multi-scenario trading strategy; and
switching the operation of the current instance, in response to the detected market event, between the default configuration to the alternate configuration such that the current instance operates according to the alternate configuration while maintaining the operation of the instance.

2. The method of claim 1, wherein the default configuration and the alternate configuration are stored before the instance of the multi-scenario trading strategy begins working in the market.

3. The method of claim 1, wherein switching the operation of the current instance comprises changing an operating parameter of the instance using configuration data available to both the default and alternate configuration.

4. The method of claim 1 further comprising:
switching, in response to receiving a revert option while the instance of the multi-scenario trading strategy is operating according to the alternate configuration, the operation of the current instance to the default configuration.

5. The method of claim 1 further comprising:
receiving a first parameter of the default configuration and the alternate configuration as part of the definition of the multi-scenario trading strategy.

6. The method of claim 1 further comprising:
switching, in response to receiving a user selection of a switching option while the instance of the multi-scenario trading strategy is operating, the operation of the current instance to a second alternate configuration, the second alternate configuration being different than the default configuration and the alternate configuration.

7. The method of claim 1, wherein switching the operation of the current instance to operate according to the default configuration comprises deactivating the second leg of the instance and activating the third leg defined according to the alternate configuration.

8. The method of claim 1, wherein switching the operation of the current instance to operate according to the default configuration comprises activating a leg of the multi-scenario trading strategy that is inactive in the default configuration.

9. The method of claim 1, wherein switching the operation of the current instance to operate according to the default configuration comprises maintaining the first leg of the multi-scenario trading strategy constant from the default configuration.

10. The method of claim 1, wherein the market event is a price change in at least one of the legs working in the market.

11. A tangible computer readable storage medium comprising instructions that, when executed, cause a machine to at least:
receive a definition for a multi-scenario trading strategy describing trade orders to be placed in at least one market, wherein the received the definition includes a default configuration for the multi-scenario trading strategy having a first leg and a second leg, and an alternate configuration for the multi-scenario trading strategy having the first leg and at least a third leg and wherein the second and the third legs are different;
implement an instance of the multi-scenario trading strategy, wherein the current instances operates according to the default configuration;
place a trade order in the at least one market such that the trade order works in the market according to the default configuration;
detect, at the trading device, a market event related to the trade order implemented in accordance with the current instance of the multi-scenario trading strategy; and
switch the operation of the current instance, in response to the detected market event, between the default configuration to the alternate configuration such that the current instance operates according to the alternate configuration while maintaining the operation of the instance.

12. An apparatus, comprising:
a computing device to enable a user to define a plurality of configurations for a multi-scenario trading strategy, the computing device responsive to a market event while an instance of the multi-scenario trading strategy is active and operating in accordance with one of the plurality of configurations of the multi-scenario trading strategy,
wherein the computing device responds to receipt of the market event while the instance is active by switching the instance from operating in accordance with the current configuration to operating in accordance with a second configuration of the multi-scenario trading strategy without requiring the user to navigate a reconfiguration interface.
